(19) United States
(12) Patent Application Publication
(10) Pub. No.: US 2013/0233785 A1
(43) Pub. Date: Sep. 12, 2013

(54) SEAWATER DESALINATION SYSTEM AND ENERGY RECOVERY APPARATUS

(71) Applicant: EBARA CORPORATION, Tokyo (JP)

(72) Inventors: Tamami TAKAHASHI, Tokyo (JP); Masanori GOTO, Tokyo (JP); Kazuaki MAEDA, Tokyo (JP)

(73) Assignee: EBARA CORPORATION, Tokyo (JP)

(21) Appl. No.: 13/786,647

(22) Filed: Mar. 6, 2013

(30) Foreign Application Priority Data
Mar. 7, 2012 (JP) 2012-50017

(51) Int. Cl. F03B 17/00; C02F 1/44

(52) U.S. Cl. CPC F03B 17/00; C02F 1/441
USPC 210/251; 60/325

(57) ABSTRACT

An energy recovery apparatus exchanges pressure energy between concentrated seawater discharged from a reverse-osmosis membrane-separation apparatus and a part of seawater to be treated by the reverse-osmosis membrane-separation apparatus in a seawater desalination system for producing fresh water from the seawater. The energy recovery apparatus includes two perforated plates provided at a concentrated seawater port side in a chamber, and two perforated plates provided at a seawater port side in the chamber. The two perforated plates comprises a first perforated plate and a second perforated plate. The first perforated plate and the second perforated plate at the concentrated seawater port side and the seawater port side are arranged to meet certain requirements including one of an open area ratio of the first perforated plate, an open area ratio of the second perforated plate, and a distance between the first perforated plate and the second perforated plate.

### CROSS REFERENCE TO RELATED APPLICATIONS

This document claims priority to Japanese Application Number 2012-050017, filed Mar. 7, 2012, the entire contents of which are hereby incorporated by reference.

### BACKGROUND OF THE INVENTION

1. Field of the Invention

The present invention relates to a seawater desalination system for desalinating seawater by removing salinity from the seawater and an energy recovery apparatus which is preferably used in the seawater desalination system.

2. Description of the Related Art

Conventionally, as a system for desalinating seawater, there has been known a seawater desalination system in which seawater passes through a reverse-osmosis membrane-separation apparatus to remove salinity from the seawater. In the seawater desalination system, the intake seawater is processed to have certain water qualities by a pretreatment system, and the pretreated seawater is delivered into the reverse-osmosis membrane-separation apparatus under pressure by a high-pressure pump. Part of the high-pressure seawater in the reverse-osmosis membrane-separation apparatus passes through a reverse-osmosis membrane against the osmotic pressure and is desalinated, and fresh water (permeate or desalted water) is taken out from the reverse-osmosis membrane-separation apparatus. The remaining seawater is discharged in a concentrated state of a high salt content as a concentrated seawater (brine) from the reverse-osmosis membrane-separation apparatus. The largest operational cost in the seawater desalination system is energy cost, and it depends heavily on energy for pressurizing the pretreated seawater up to such a pressure to overcome the osmotic pressure, i.e. up to the reverse-osmosis pressure. That is, the operational cost of the seawater desalination system is greatly affected by pressurizing energy of the seawater by the high-pressure pump.

Specifically, more than half of the electric expenses as the highest cost in the seawater desalination system are consumed to operate the high-pressure pump for pressurizing the seawater. Therefore, pressure energy possessed by the high-pressure concentrated seawater (reject) with the high salt content which has been discharged from the reverse-osmosis membrane-separation apparatus is utilized for pressurizing part of the seawater. Therefore, as a means for utilizing the pressure energy of the concentrated seawater discharged from the reverse-osmosis membrane-separation apparatus to pressurize part of the seawater, there has been utilized an energy recovery chamber in which an interior of a cylinder is separated into two spaces by a piston arranged to be movable in the cylinder, a concentrated seawater port is provided in one of the two separated spaces to introduce and discharge the concentrated seawater, and a seawater port is provided in the other of the two separated spaces to introduce and discharge the seawater.

FIG. 9 is a schematic view showing a configuration example of a conventional seawater desalination system. As shown in FIG. 9, seawater pumped into the seawater desalination system by an intake pump (not shown) is processed to have certain water qualities by a pretreatment system for removing suspended matter, and then the pretreated seawater is delivered via a seawater supply line 1 into a high-pressure pump 2 that is driven by a motor M. The seawater which has been pressurized by the high-pressure pump 2 is supplied via a discharge line 3 to a reverse-osmosis membrane-separation apparatus 4 having a reverse-osmosis membrane (RO membrane). The reverse-osmosis membrane-separation apparatus 4 separates the seawater into concentrated seawater with a high salt content and fresh water with a low salt content and obtains the fresh water from the seawater. At this time, the concentrated seawater with a high salt content is discharged from the reverse-osmosis membrane-separation apparatus 4, and the discharged concentrated seawater still has a high-pressure. A concentrated seawater line 5 for discharging the concentrated seawater from the reverse-osmosis membrane-separation apparatus 4 is connected via a control valve 6 to a concentrated seawater port P1 of an energy recovery chamber 10. A seawater supply line 1 for supplying the pretreated seawater having a low pressure is branched at an upstream side of the high-pressure pump 2 and is connected via a valve 7 to a seawater port P2 of the energy recovery chamber 10. The energy recovery chamber 10 has a piston 12 therein, and the piston 12 is arranged to be movable in the energy recovery chamber 10.

The seawater pressurized by utilizing a pressure of the concentrated seawater in the energy recovery chamber 10 is supplied via the valve 7 to a booster pump 8. Then, the seawater is further pressurized by the booster pump 8 so that the seawater has the same pressure level as the discharge line 3 of the high-pressure pump 2, and the pressurized seawater merges via a valve 9 into the discharge line 3 of the high-pressure pump 2 and is then supplied to the reverse-osmosis membrane-separation apparatus 4.

In the above-described conventional energy recovery apparatus, the piston in the energy recovery apparatus is brought into sliding contact with the inner wall of the chamber, and thus the sliding member of the piston is required to be periodically replaced due to wear of the sliding member. Further, the inner diameter of the long chamber is required to be machined with high accuracy so as to fit with the outer shape of the piston, and thus machining cost is very expensive.

Therefore, the applicants of the present invention have proposed an energy recovery apparatus having no piston in which a cylindrical and elongated chamber is used as a pressure recovery apparatus and a plurality of partitioned fluid passages are provided in the chamber to directly pressurize the seawater with the high-pressure concentrated seawater which is discharged from the reverse-osmosis membrane (RO membrane) in Japanese laid-open patent publication No. 2010-284642.

### SUMMARY OF THE INVENTION

In the energy recovery chamber disclosed in Japanese laid-open patent publication No. 2010-284642, spaces are provided between a concentrated seawater port and a plurality of fluid passages, and between a seawater port and the plurality of fluid passages. Perforated plates as flow regulators for regulating a flow of fluid when the fluid flows into each of the spaces are provided in each of the spaces to distribute the flow which has entered through the port having a small diameter into the chamber having a large diameter uniformly and to form uniform flow into the plurality of the partitioned fluid passages.

The present inventors have analyzed, by computer simulation, the energy recovery chamber in which an interface between the concentrated seawater and the seawater moves in the interior of the chamber by a pressure balance between the concentrated seawater and the seawater, as disclosed in Japanese laid-open patent publication No. 2010-284642. Through such analysis, the present inventors have found that the key point for suppressing the mixture of the concentrated seawater and the seawater is to make local flows which has entered into the energy recovery chamber having a large diameter through the small diameter ports (inlet and outlet) for supplying and discharging the concentrated seawater/seawater, a uniform flow in a circular cross section perpendicular to an axial direction of the chamber, and have studied several uniformalizing structures. As a result, the present inventors have found that the simplest structure is a chamber in which two perforated plates are disposed in the vicinity of each of the ports.

Then, the present inventors have derived the optimum conditions for arranging the two perforated plates through flow analysis and design of experiments by using parameters such as an inner diameter of the chamber, the arranged positions of the perforated plates, and open area ratio of the perforated plates, and have achieved the present invention.

It is therefore an object of the present invention to provide an energy recovery apparatus which can uniformalize a flow of fluid which has entered into a chamber through each of a concentrated seawater port and a seawater port in a cross section perpendicular to an axial direction of the chamber, by providing two perforated plates at each of a concentrated seawater port side and a seawater port side in the chamber, and arranging the two perforated plates so as to meet a predetermined requirement.

In order to achieve the above object, according to one aspect of the present invention, there is provided an energy recovery apparatus for exchanging pressure energy between concentrated seawater discharged from a reverse-osmosis membrane-separation apparatus and a part of seawater to be treated by the reverse-osmosis membrane-separation apparatus in a seawater desalination system for producing fresh water from the seawater by supplying the seawater to the reverse-osmosis membrane-separation apparatus to separate the seawater into fresh water and concentrated seawater, the energy recovery apparatus comprising: a cylindrical chamber having a space for containing concentrated seawater and seawater therein, the chamber being installed such that a longitudinal direction of the chamber is placed in a vertical direction; a concentrated seawater port provided at a lower part of the chamber for supplying and discharging the concentrated seawater; a seawater port provided at an upper part of the chamber for supplying and discharging the seawater; two perforated plates provided at a concentrated seawater port side in the chamber, the two perforated plates comprising a first perforated plate and a second perforated plate which is placed more distant from the concentrated seawater port than the first perforated plate; and two perforated plates provided at a seawater port side in the chamber, the two perforated plates comprising a first perforated plate and a second perforated plate which is placed more distant from the seawater port than the first perforated plate; wherein the first perforated plate and the second perforated plate at the concentrated seawater port side and the seawater port side are arranged to meet one of the following three requirements: an open area ratio of the first perforated plate is in the range of 45 to 60%; an open area ratio of the second perforated plate is in the range of 45 to 60%; and a distance between the first perforated plate and the second perforated plate is not less than 0.5 times of an inner diameter of the chamber.

According to the present invention, the concentrated seawater is supplied to and discharged from the chamber through the concentrated seawater port provided at the lower part of the chamber, and the seawater is supplied to and discharged from the chamber through the seawater port provided at the upper part of the chamber. The concentrated seawater which has flowed into the chamber is regulated in its flow by the first perforated plate and the second perforated plate at the concentrated seawater port side, and the seawater which has flowed into the chamber is regulated in its flow by the first perforated plate and the second perforated plate at the seawater port side. Since the concentrated seawater has higher specific gravity than the seawater, a boundary between the concentrated seawater and the seawater is formed due to the difference in the specific gravity, and the concentrated seawater pushes up the seawater. Thus, the pressure can be transmitted from the high-pressure concentrated seawater to the seawater while the concentrated seawater and the seawater are separated into upper and lower and mixing of the two fluids at the boundary where the two fluids are brought into contact with each other is suppressed.

According to the present invention, the flow-regulating effect for uniformalizing the fluid flow can be obtained by adjusting at least one of the following requirements: an open area ratio of the first perforated plate provided at the concentrated seawater port side and the seawater port side in the chamber; an open area ratio of the second perforated plate provided at the concentrated seawater port side and the seawater port side in the chamber; and a distance between the first perforated plate and the second perforated plate.

In a preferred aspect of the present invention, the first perforated plate and the second perforated plate at the concentrated seawater port side and the seawater port side are arranged to meet one of the following requirements: the open area ratio of the first perforated plate is in the range of 45 to 60% and the open area ratio of the second perforated plate is in the range of 45 to 60%; and the open area ratio of the first perforated plate is in the range of 45 to 60% and the distance between the first perforated plate and the second perforated plate is not less than 0.5 times of the inner diameter of the chamber.

In a preferred aspect of the present invention, the first perforated plate and the second perforated plate at the concentrated seawater port side and the seawater port side are arranged to meet all of the following requirements: the open area ratio of the first perforated plate is in the range of 45 to 60%; the open area ratio of the second perforated plate is in the range of 45 to 60%; and the distance between the first perforated plate and the second perforated plate is not less than 0.5 times of the inner diameter of the chamber.

In a preferred aspect of the present invention, the distance between the first perforated plate and the second perforated plate is in the range of 0.5 to 0.8 times of the inner diameter of the chamber.

According to another aspect of the present invention, there is provided a seawater desalination system for producing fresh water from seawater by supplying the seawater to a reverse-osmosis membrane-separation apparatus to separate the seawater into fresh water and concentrated seawater, the seawater desalination system comprising: the energy recovery apparatus according to claim 1 for exchanging pressure energy between the concentrated seawater discharged from the reverse-osmosis membrane-separation apparatus and a part of the seawater to be treated by the reverse-osmosis membrane-separation apparatus.

According to the present invention, the following effects can be achieved.

1) A pressure can be transmitted from high-pressure concentrated seawater to seawater while the seawater and the concentrated seawater are separated into upper and lower by utilizing a difference in specific gravity by supplying and discharging the concentrated seawater from a lower part of the chamber and by supplying and discharging the seawater from an upper part of the chamber, and while mixing of the seawater and the concentrated seawater is suppressed at a boundary where the two fluids are brought into contact with each other by the flow-regulating effect for uniformalizing the fluid flow with the perforated plates.

2) Because mixing of the concentrated seawater and the seawater in the chamber due to turbulent flow diffusion can be suppressed and the seawater having a high salt content is not delivered to the reverse-osmosis membrane-separation apparatus, the reverse-osmosis membrane-separation apparatus can provide its sufficient performance and the replacement cycle of the reverse-osmosis membrane itself can be prolonged.

### BRIEF DESCRIPTION OF THE DRAWINGS

FIG. 1 is a schematic view showing a configuration example of a seawater desalination system according to the present invention;

FIG. 2 is a cross-sectional view showing a configuration example of a chamber used in an energy recovery apparatus according to the present invention;

FIG. 3A is a plan view of a perforated plate used in the energy recovery apparatus according to the present invention;

FIG. 3B is an enlarged view of part A of FIG. 3A;

FIG. 4 is a table showing analysis result data of flow velocities obtained through procedures of DOM;

FIG. 5 are graphs showing main effects of six parameters on the flow velocities at an evaluation section;

FIG. 6 are graphs showing interactions between six parameters on the flow velocities;

FIG. 7A is a view showing a contour map of non-dimensional flow velocities at an evaluation section, obtained by CFD;

FIG. 7B is a view showing velocity vectors in the chamber, obtained by CFD;

FIG. 8A is a view showing a contour map of non-dimensional flow velocities at an evaluation section, obtained by CFD;

FIG. 8B is a view showing velocity vectors in the chamber, obtained by CFD; and

FIG. 9 is a schematic view showing a configuration example of a conventional seawater desalination system.

### DETAILED DESCRIPTION OF THE PREFERRED EMBODIMENTS

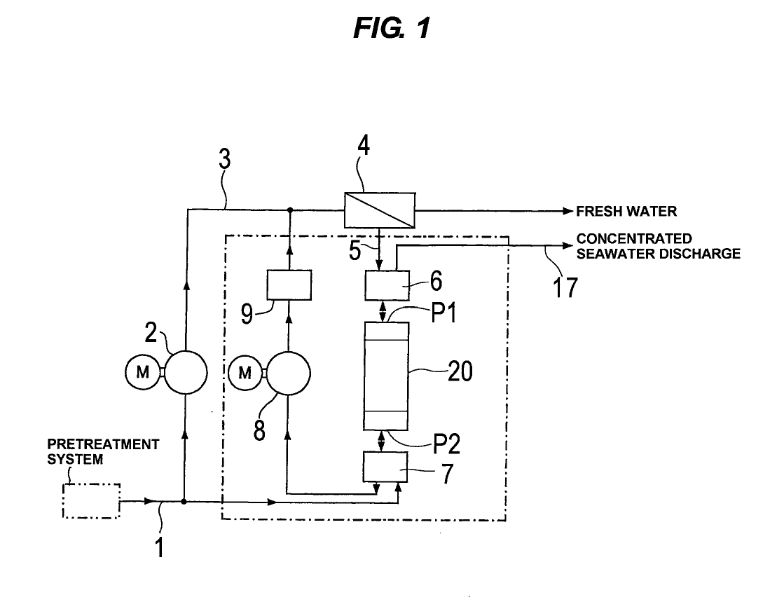

A seawater desalination system according to preferred embodiments of the present invention will be described in detail below with reference to FIGS. 1 through 8. Like or corresponding parts are denoted by like or corresponding reference numerals in FIGS. 1 through 8 and will not be described below repetitively.

FIG. 1 is a schematic view showing a configuration example of a seawater desalination system according to the present invention. As shown in FIG. 1, seawater pumped into the seawater desalination system by an intake pump (not shown) is processed to have certain water qualities by a pretreatment system, and then the pretreated seawater is delivered via a seawater supply line 1 into a high-pressure pump 2 that is driven by a motor M. The seawater which has been pressurized by the high-pressure pump 2 is supplied via a discharge line 3 to a reverse-osmosis membrane-separation apparatus 4 having a reverse-osmosis membrane (RO membrane). The reverse-osmosis membrane-separation apparatus 4 separates the seawater into concentrated seawater (reject or brine) with a high salt content and fresh water (permeate or desalted water) with a low salt content and obtains the fresh water from the seawater. At this time, the concentrated seawater with a high salt content is discharged from the reverse-osmosis membrane-separation apparatus 4, and the discharged concentrated seawater still has a high-pressure. A concentrated seawater line 5 for discharging the concentrated seawater from the reverse-osmosis membrane-separation apparatus 4 is connected via a control valve 6 to a concentrated seawater port P1 of an energy recovery chamber 20. A seawater supply line 1 for supplying the pretreated seawater having a low pressure is branched at an upstream side of the high-pressure pump 2 and is connected via a valve 7 to a seawater port P2 of the energy recovery chamber 20. The energy recovery chamber 20 performs energy transmission from the high-pressure concentrated seawater to the low-pressure seawater while separating two fluids by a boundary between the concentrated seawater and the seawater.

The seawater pressurized by utilizing a pressure of the concentrated seawater in the energy recovery chamber 20 is supplied via a valve 7 to a booster pump 8. Then, the seawater is further pressurized by the booster pump 8 so that the seawater has the same pressure level as the discharge line 3 of the high-pressure pump 2, and the pressurized seawater merges via a valve 9 into the discharge line 3 of the high-pressure pump 2 and is then supplied to the reverse-osmosis membrane-separation apparatus 4. On the other hand, the concentrated seawater which has pressurized the seawater and lost the energy is discharged from the energy recovery chamber 20 via the control valve 6 to a concentrated seawater discharge line 17.

When the pressure of the discharge line 3 of the high-pressure pump 2 is 6.5 MPa for example, the pressure is slightly lowered by pressure loss of the RO membrane of the reverse-osmosis membrane-separation apparatus 4, and the concentrated seawater having a pressure of 6.4 MPa is discharged from the reverse-osmosis membrane-separation apparatus 4. When the pressure energy of the concentrated seawater acts on the seawater, the seawater is pressurized to the same pressure (6.4 MPa), but the pressure is decreased by pressure loss of the energy recovery apparatus itself when the seawater flows through the energy recovery apparatus, and the seawater having a pressure of 6.3 MPa for example is discharged from the energy recovery apparatus. The booster pump 8 slightly pressurizes the seawater from 6.3 MPa to 6.5 MPa, and the seawater merges into the discharge line 3 of the high-pressure pump 2 and is supplied to the reverse-osmosis membrane-separation apparatus 4. The booster pump 8 only needs to pressurize the seawater to make up for such a small pressure loss, and thus a small amount of energy is consumed in the booster pump 8.

It is assumed that 100% of an amount of seawater is supplied to the reverse-osmosis membrane-separation apparatus 4, 40% of the amount of the seawater can be changed to fresh water. The remaining 60% of the amount of the seawater is concentrated and discharged from the reverse-osmosis membrane-separation apparatus 4 as concentrated seawater. Then, the pressure of the 60% concentrated seawater is transmitted and recovered by the seawater in the energy recovery apparatus, and the seawater having an increased pressure is discharged from the energy recovery chamber. Therefore, the seawater having a high pressure equivalent to the seawater pressurized by the high-pressure pump can be obtained, with a small amount of energy consumed by the booster pump. Thus, the energy which is consumed by the high-pressure pump to produce the fresh water can be about half of the energy in the case of no energy recovery apparatus.

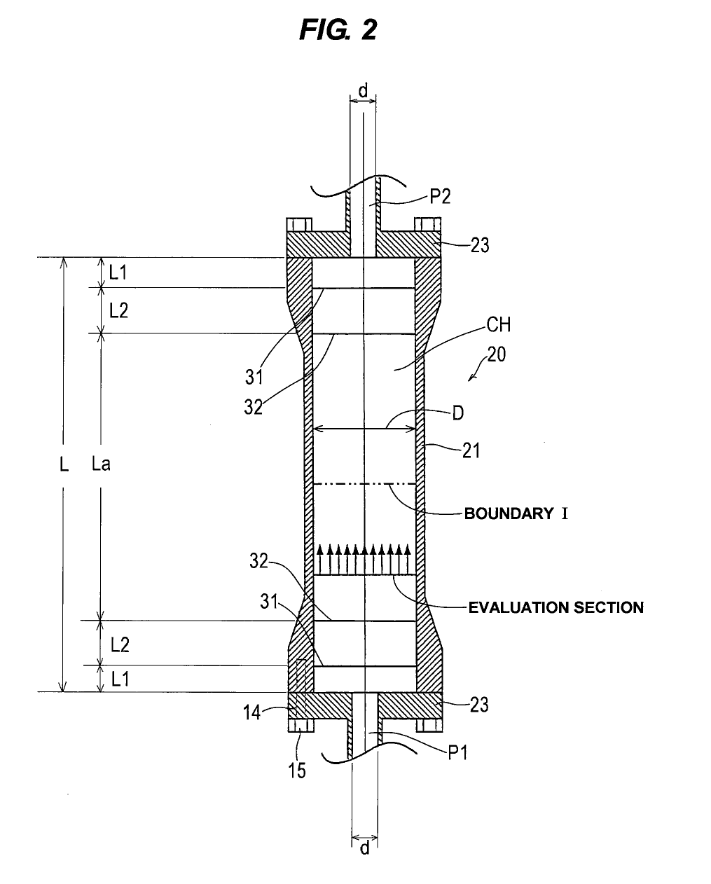

FIG. 2 is a cross-sectional view showing the energy recovery chamber having perforated plates therein. As shown in FIG. 2, the energy recovery chamber 20 comprises a long chamber body 21 having a cylindrical shape, and flanges 23 for closing both opening ends of the chamber body 21. A chamber CH is formed in the chamber body 21, and a concentrated seawater port P1 is formed in one of the flanges 23 and a seawater port P2 is formed in the other of the flanges 23. The chamber body 21 has large diameter portions having larger outer diameters at both ends than an outer diameter at a central portion of the chamber body 21, and stud bolts 14 are embedded in the large diameter portions. The stud bolts 14 are fixed so as to project from the ends of the flanges 23, and nuts 15 are fastened to the stud bolts 14 to fix the flanges 23 to the chamber body 21.

In the present embodiment, the energy recovery chamber 20 is installed vertically. That is, the long chamber body 21 having a cylindrical shape is installed such that a longitudinal direction (axial direction) of the chamber is placed in a vertical direction. The concentrated seawater port P1 is provided at a lower part of the chamber CH for supplying and discharging the concentrated seawater at the lower part of the chamber CH, and the seawater port P2 is provided at an upper part of the chamber CH for supplying and discharging the seawater at the upper part of the chamber CH. The concentrated seawater port P1 and the seawater port P2 comprise fluid passages having an inner diameter d which is smaller than an inner diameter D of the energy recovery chamber 20. In the chamber CH having an entire length L, a first perforated plate 31 is provided at a position spaced by a distance L1 in the axial direction from the concentrated seawater port P1, and a second perforated plate 32 is provided at a position spaced by a distance L2 in the axial direction from the first perforated plate 31. A first perforated plate 31 is provided at a position spaced by a distance L1 in the axial direction from the seawater port P2, and a second perforated plate 32 is provided at a position spaced by a distance L2 in the axial direction from the first perforated plate 31.

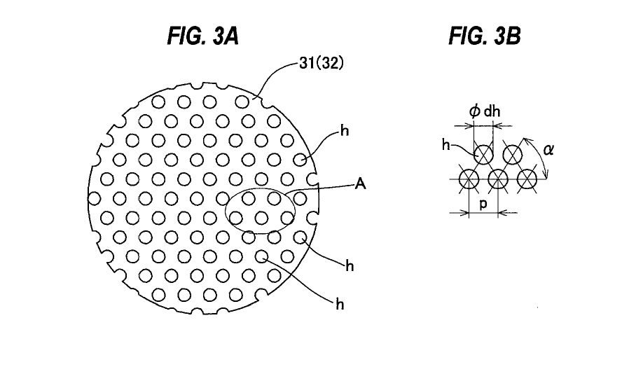

FIG. 3A is a plan view of the first perforated plate 31 or the second perforated plate 32. As shown in FIG. 3A, the perforated plate 31 (32) is so-called a punched plate which comprises a circular flat plate having a number of small holes h formed at uniform intervals. A number of the holes h having a small diameter are provided in a staggered arrangement. FIG. 3B is an enlarged view of part A of FIG. 3A. The holes h having a small diameter are arranged in so-called 60 degree staggered pattern, and these holes are placed so that two lines passing through centers of the holes cross each other at an angle of α=60 degrees. A diameter of each of the holes is (1)dh, and a distance (pitch) between centers of the adjacent holes is p. In this manner, by arranging the two perforated plates 31, 32 for regulating the fluid in the vicinity of each of the ports P1, P2, the flow which has entered through the ports P1, P2 having a small diameter into the chamber CH having a large diameter can be uniformly flowed in the chamber CH. That is, local flows which have flowed into the chamber from the respective ports P1, P2 are uniformalized in the zone indicated as La in FIG. 2 by the perforated plate 31 and the perforated plate 32. As regulating means for uniformalizing the flow in the zone indicated as La, the arrangement of the two perforated plates is the simplest configuration. The arrangement of one perforated plate is not enough to have uniformalizing effect of the flow, and the arrangement of three perforated plates have uniformalizing effect of the flow which is not substantially different from that of the two perforated plates. Therefore, the arrangement of two perforated plates has been selected.

The ratio of the area of holes with respect to an entire area of the perforated plate (open area ratio) is calculated by an array of holes, the diameter Oh of the small hole h, and the pitch p between the two adjacent holes. In the case of the 60 degree staggered pattern as shown in FIG. 3, when the diameter of hole is Oh and the pitch is p, an open area ratio F is calculated by the following formula.

F=(90.6×dh²)/p²

The perforated plate may be any perforated plate as long as it has a function to present a desired resistance to the fluid flow and to distribute the fluid uniformly, such as a perforated plate which has another array of holes or another shape of holes. The perforated plate may be a metal mesh in which metal wires are woven one another.

Here, a uniform flow of fluid means that velocities and directions of fluid flow are uniform in a certain horizontal cross-section of the chamber CH. Specifically, it means that in the case where a length of arrow and a direction of arrow are defined as flow velocity of fluid and flow direction of fluid, respectively, at any given horizontal cross-section (evaluation section) in the zone shown as La in FIG. 2 in the chamber CH, all arrows have the same length and the same direction. This fluid flow can be adjusted by the open area ratios of the two perforated plates 31, 32 and the positions of the two perforated plates 31, 32 which are installed in the chamber CH. The dimension, the open area ratio, and the position of the perforated plate are optimized by analysis.

The seawater and the concentrated seawater which have flowed uniformly into the zone La through the perforated plates 31, 32 are separated into upper and lower by the difference in specific gravity, and simultaneously uniform flow is formed in a vertical direction in the cross-sectional area of the chamber, and thus the boundary I between the concentrated seawater and the seawater is maintained. As a whole, while the boundary I between the concentrated seawater and the seawater is maintained, i.e., while mixing of the concentrated seawater and the seawater is suppressed, the seawater is pressurized and discharged by the concentrated seawater.

Based on Design Of Experiment (DOE), analysis result data of flow velocities and main effects and interactions of non-dimensional standard deviation of flow velocities obtained from the analysis result data, will be described below.

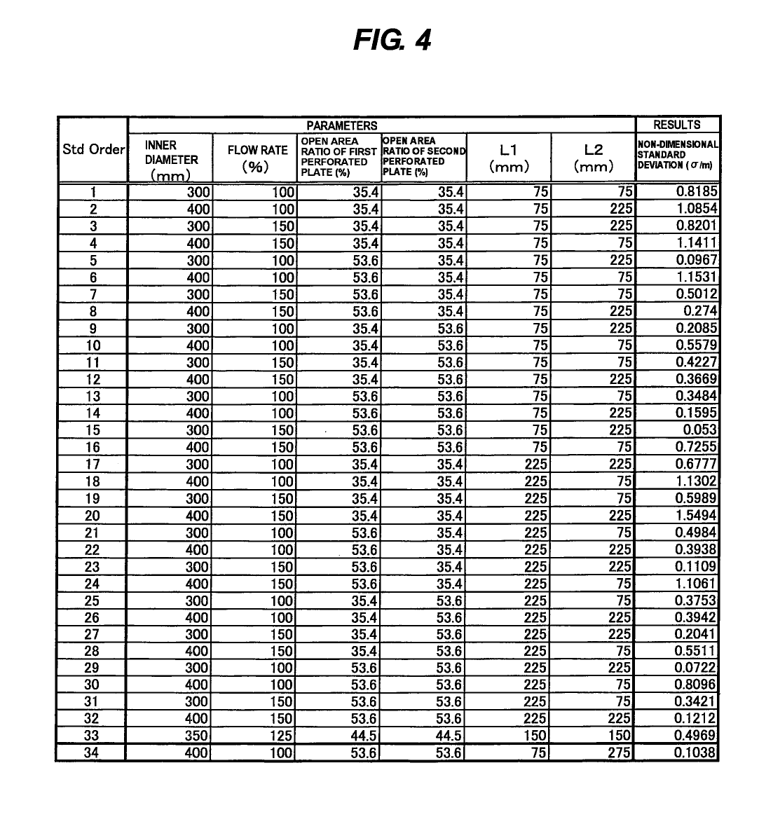

A table of FIG. 4 shows analysis results in the case where parameters including an inner diameter of the chamber, a flow rate, an open area ratio of the first perforated plate, an open area ratio of the second perforated plate, a distance L1, and a distance L2 are changed in various combinations, and shows non-dimensional standard deviations σ/m based on distribution of flow velocities at an evaluation section, as analysis results.

In the table of FIG. 4, analysis combinations in item 1 to item 34 were obtained through procedures of DOE. Since two corner values are provided for each of the six parameters, 2⁶ (2 to the 6th power) combinations, i.e., 64 combinations of the corner values are possible. 32 combinations of them are shown from item 1 to item 32. The data in item 33 are calculation results at median of the respective parameters, and the data in item 34 are calculation results in the case where the value of L2 in item 14 was changed from 225 (mm) to 275 (mm) and calculation was made in the same manner.

The distribution of the flow velocities at the evaluation section is obtained by CFD (Computational Fluid Dynamics) analysis, and average flow velocity m and standard deviation σ are obtained, by changing each of the parameters. Then, as shown in the table of FIG. 4, non-dimensional standard deviation a/m is obtained by dividing the standard deviation a by the average flow velocity m. By obtaining the non-dimensional standard deviation σ/m, influence caused by variation of the average flow velocities with respect to the distribution of the flow velocities is eliminated, and thus the distribution of the flow velocities at the evaluation section can be analyzed more appropriately.

The design factor type of the inner diameter (mm) of the chamber is a 3-factor type of the smallest corner value, the largest corner value and median value, 300 mm, 400 mm and 350 mm, respectively. With regard to the design factor type of the flow rate (%), the corner values are Q×100% and Q×150%, and the median is Q×125%, with respect to the rated treatment flow rate Q (L/min) of the energy recovery apparatus. With regard to the design factor type of the open area ratio (%) of the first perforated plate, the corner values are 35.4% and 53.6%, and the median is 44.5%. With regard to the design factor point type of the open area ratio (%) of the second perforated plate, the corner values are 35.4% and 53.6%, and the median is 44.5%. With regard to the design factor type of the distance L1 (mm) and the distance L2 (mm), the corner values are 75 mm and 225 mm, and the median is 150 mm.

The open area ratios (%) of the first perforated plate and the second perforated plate are 35.4% when φdh is 5 mm and p is 8 mm in FIG. 3, and 53.6% when φdh is 5 mm and p is 6.5 mm in FIG. 3. Because each of the perforated plates causes a resistance to the fluid flow, if the open area ratio is smaller than the setting value, then pressure loss in the perforated plate is increased and energy recovery efficiency is decreased. And furthermore, the strength of the perforated plate itself needs to be enhanced. Conversely, if the open area ratio is large, sufficient uniformalizing effect cannot be obtained. Therefore, the open area ratio is set in the range of 45% to 60% as appropriate range determined by prior analysis.

With respect to the minimum corner value and the maximum corner value of each of the parameters, the values approximate to the estimated minimum and maximum values for the energy recovery apparatus used in the seawater desalination system, are selected and used for calculation, as described above. In the present analysis in which two corner values are provided for each of the six parameters, as shown in table of FIG. 4, analysis has been conducted with 32 combinations (items 1 to 32) of each of the parameters.

In all of items 1 to 34, the position of the evaluation section in the chamber is set such that the distance between the second perforated plate and the evaluation section is 150 mm.

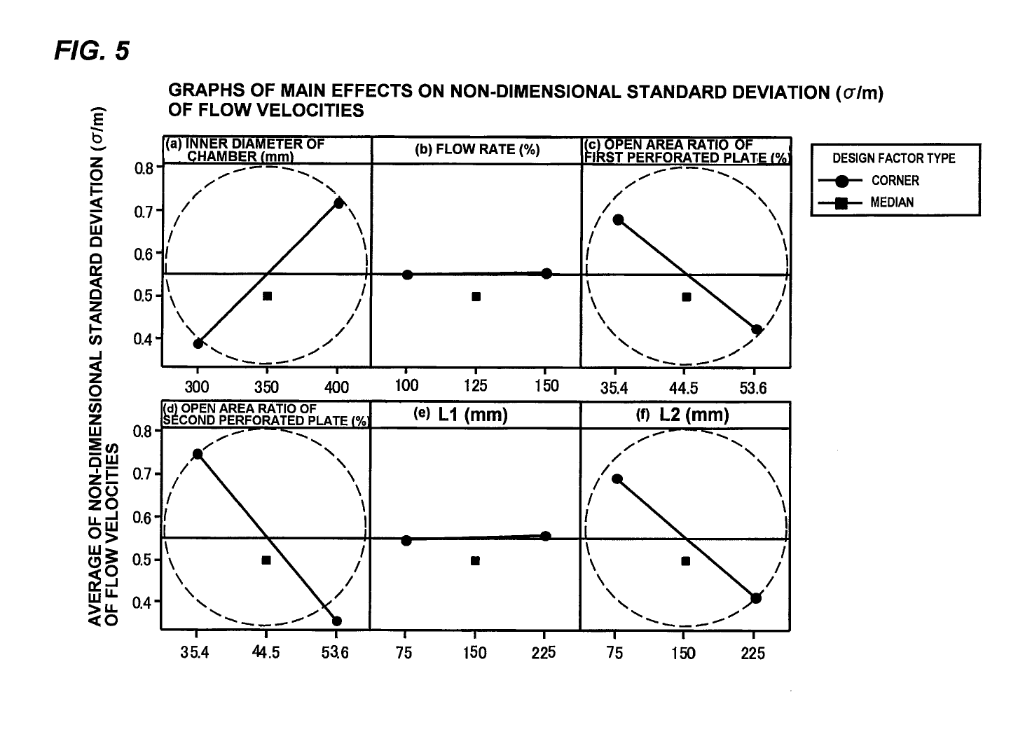

FIG. 5 are graphs showing main effects of six parameters on non-dimensional standard deviation σ/m of flow velocities at the evaluation section. Graph (a) shows main effect of the inner diameter of the chamber, Graph (b) shows main effect of the flow rate, Graph (c) shows main effect of the open area ratio of the first perforated plate, Graph (d) shows main effect of the open area ratio of the second perforated plate, Graph (e) shows main effect of the distance L1, and Graph (f) shows main effect of the distance L2. The horizontal axis represents each of the parameters, and the vertical axis represents non-dimensional standard deviation σ/m of flow velocities at the evaluation section.

In Graphs (a) to (f), the average values of non-dimensional standard deviation at the corners (the minimum and the maximum) are plotted for each of the parameters, and the plotted two dots are connected with a straight line. The central square dots are median corresponding to the values in item 33 of FIG. 4.

In each of the parameters, when the straight line connecting the two dots representing the corners is inclined, it can be understood that the parameter is significant against the non-dimensional standard deviation of the flow velocities, i.e., the parameter has a certain effect on the deviation of flow velocity. In Graph (b) and (e), the straight lines connecting the two dots representing the corners are hardly inclined. It means that the flow rate and the distance L1 have little effect on the deviation of flow velocity.

On the other hand, in Graphs (a), (c), (d) and (f), straight lines connecting the two dots representing the corners are inclined greatly. It means that the parameters of Graph (a), (c), (d) and (f) have respective directionalities to lessen the non-dimensional standard deviation of the flow velocities. Specifically, Graph (a) indicates that as the inner diameter of the chamber is smaller, the variation of the distribution of the flow velocities is smaller. Graph (c) indicates that as the open area ratio of the first perforated plate is larger, the non-dimensional standard deviation of the flow velocities is smaller. Graph (d) indicates that as the open area ratio of the second perforated plate is larger, the non-dimensional standard deviation of the flow velocities is smaller. Further, Graph (f) indicates that as the distance L2 is larger, the non-dimensional standard deviation of the flow velocities is smaller. In this manner, the open area ratio of the first perforated plate, the open area ratio of the second perforated plate, and the distance L2 have effects on the non-dimensional standard deviation of the flow velocities.

With respect to the open area ratio of the perforated plate, the range of the open area ratio is selected within the range to obtain the flow-regulating effect in consideration of the fact that as the open area ratio is smaller, pressure loss of the chamber is larger. Because the open area ratios at the median of the first perforated plate and the second perforated plate are 44.5%, it is preferable that each open area ratio of the first perforated plate and the second perforated plate is greater than about 45%. The analysis is conducted in a condition that the maximum corner value is 53.6%, and it is supposed to have a trend to lessen the non-dimensional standard deviation of the flow velocities even if the open area ratio is equal to or greater than 53.6%. However, because the flow-regulating effect is lessened if the open area ratio is greater than 60%, the open area ratios of the first perforated plate and the second perforated plate are preferably in the range of about 45% to 60%.

Since the distance L2 is 150 mm at its median, in the case where the inner diameter of the chamber is 300 mm, the distance L2 at its median is 0.5 times of the inner diameter of the chamber. It is preferable that the distance L2 is equal to or greater than 0.5 times of the inner diameter of the chamber, because as shown in data of item 14 and item 34 in the table of FIG. 4, it is supposed that the greater distance L2 makes the flow velocity of the fluid more uniform. Since the distance L2 is 225 mm at the maximum corner value, if the inner diameter of the chamber is 300 mm, the distance L2 is 0.75 times of the inner diameter of the chamber. Therefore, it is preferable that the distance L2 is in the range of about 0.5 times to 0.8 times of the inner diameter of the chamber.

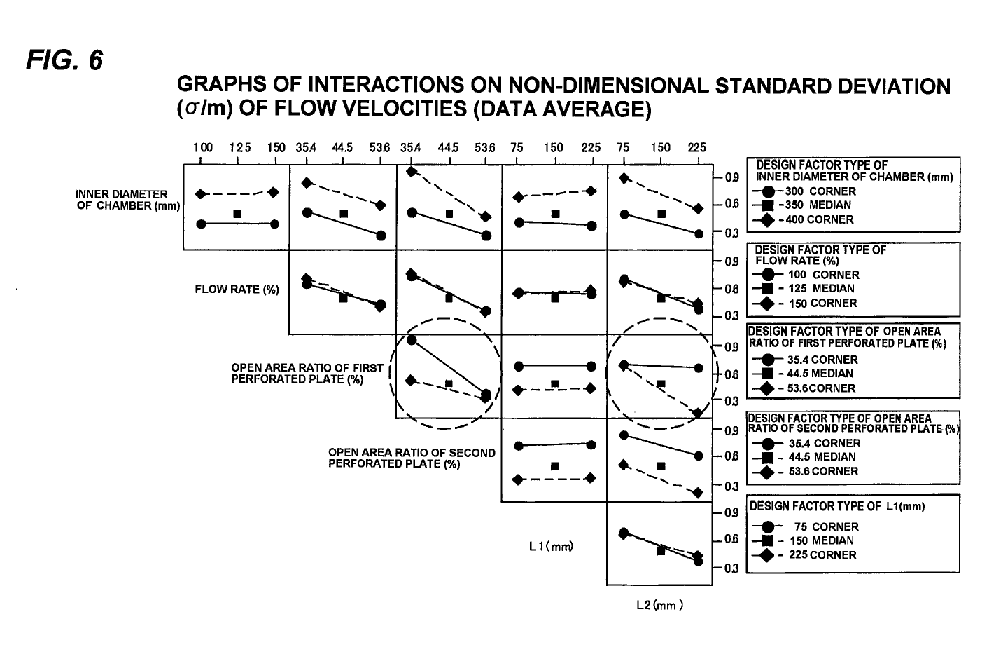

Graphs of FIG. 6 show effectiveness and interactions between the above six parameters on the non-dimensional standard deviation of the flow velocities. In each of the graphs shown in FIG. 6, the average values are plotted using the analysis results shown in the table of FIG. 4, and the plotted two dots are connected with straight lines. Since there are 15 combinations in the case where two parameters are selected from 6 parameters, 15 graphs are shown in FIG. 6. The vertical axis of each graph represents non-dimensional standard deviation of the flow velocities, and the horizontal axis represents the minimum corner value, the median, and the maximum corner value of each parameter. In the right end of FIG. 6, the design factor type of the inner diameter (mm) of the chamber, the design factor type of the flow rate (%), the design factor type of the open area ratio (%) of the first perforated plate, the design factor type of the open area ratio (%) of the second perforated plate, and the design factor type of the distance L1 (mm) are shown as the legend, from the top to the bottom.

In FIG. 6, five graphs on the top row show, from left to right, each of the relationships between the inner diameter of the chamber and the flow rate, the inner diameter of the chamber and the open area ratio of the first perforated plate, the inner diameter of the chamber and the open area ratio of the second perforated plate, the inner diameter of the chamber and the distance L1, and the inner diameter of the chamber and the distance L2.

The leftmost graph on the top row in FIG. 6 shows the non-dimensional standard deviation of the flow velocities in the case where the inner diameter of the chamber and the flow rate are changed. The round dots represent the case where the inner diameter of the chamber is 300 mm, lozenge dots represent the case where the inner diameter of the chamber is 400 mm, and square dot represent the median. From this graph, it is understood that in the relationship between the non-dimensional standard deviation of the flow velocities and the flow rate, two lines are substantially flat and parallel even when the inner diameter is changed, and the non-dimensional standard deviation of the flow velocities is not varied. Thus, the inner diameter of the chamber and the flow rate do not affect each other.

Here, in consideration of the results of FIG. 5, attention is given to the open area ratio of the first perforated plate, the open area ratio of the second perforated plate, and the distance L2 in the graphs of FIG. 6. Within 15 graphs of FIG. 6, two graphs which are clearly supposed to have interactions are circled with dashed lines.

In the graph (the left one circled with a dashed line) in which the non-dimensional standard deviation of the flow velocities are plotted while the open area ratio of the first perforated plate and the open area ratio of the second perforated plate are changed, the inclinations of the two lines differ greatly. It means that the open area ratio of the first perforated plate and the open area ratio of the second perforated plate have interaction on the non-dimensional standard deviation of the flow velocities. Specifically, the non-dimensional standard deviation of the flow velocities is lessened when the open area ratio of the second perforated plate is large, even if the open area ratio of the first perforated plate is small. Based on this graph, it is understood that the non-dimensional standard deviation of the flow velocities is lessened when both of the open area ratio of the first perforated plate and the open area ratio of the second perforated plate are larger. Thus, it is preferable that the open area ratio of the first perforated plate and the second perforated plate are in the range of about 45% to 60%.

Next, in the graph (the right one circled with a dashed line) in which the relationship between the open area ratio of the first perforated plate and the distance L2 is shown, the inclinations of two lines which show the effect on the non-dimensional standard deviation of the flow velocities by the distance L2 differ greatly, when the open area ratio of the first perforated plate is changed. It means that the open area ratio of the first perforated plate makes a significant difference to the effectiveness on the non-dimensional standard deviation of the flow velocities by the distance L2. That is, it is understood that the open area ratio of the first perforated plate and the distance L2 affect each other. However, if the open area ratio of the first perforated plate is small, the non-dimensional standard deviation of the flow velocities is not lessened even if the distance L2 is larger. Based on this graph, it is understood that the non-dimensional standard deviation of the flow velocities is lessened when the open area ratio of the first perforated plate is larger and the distance L2 is larger. Thus, it is preferable that the open area ratio of the first perforated plate is in the range of about 45% to 60% and the distance L2 is not less than about 0.5 times of the inner diameter of the chamber.

As described above, it is understood that the better results can be achieved by appropriately selecting the combination of the open area ratio of the first perforated plate and the open area ratio of the second perforated plate, or the combination of the open area ratio of the first perforated plate and the distance L2.

Specifically, based on FIG. 5, it is understood that the open area ratio of the first perforated plate, the open area ratio of the second perforated plate, the distance L2 and the inner diameter of the chamber are significant. As a conclusion based on combination of graphs of FIG. 5 and graphs of FIG. 6, the state that the non-dimensional standard deviation of the flow velocities is lessened, i.e., variation of the flow velocities is eliminated, is notably influenced by adjusting the combination of the open area ratio of the first perforated plate and the open area ratio of the second perforated plate and the combination of the open area ratio of the first perforated plate and the distance L2.

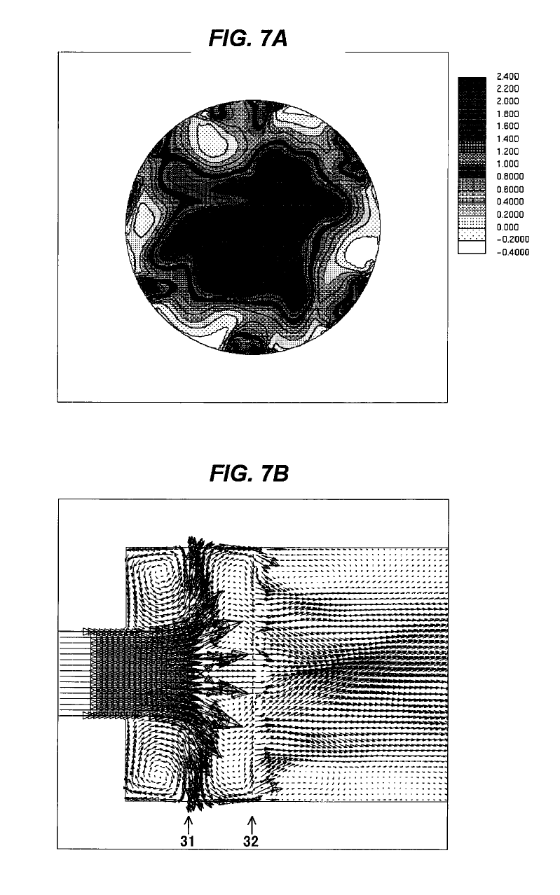

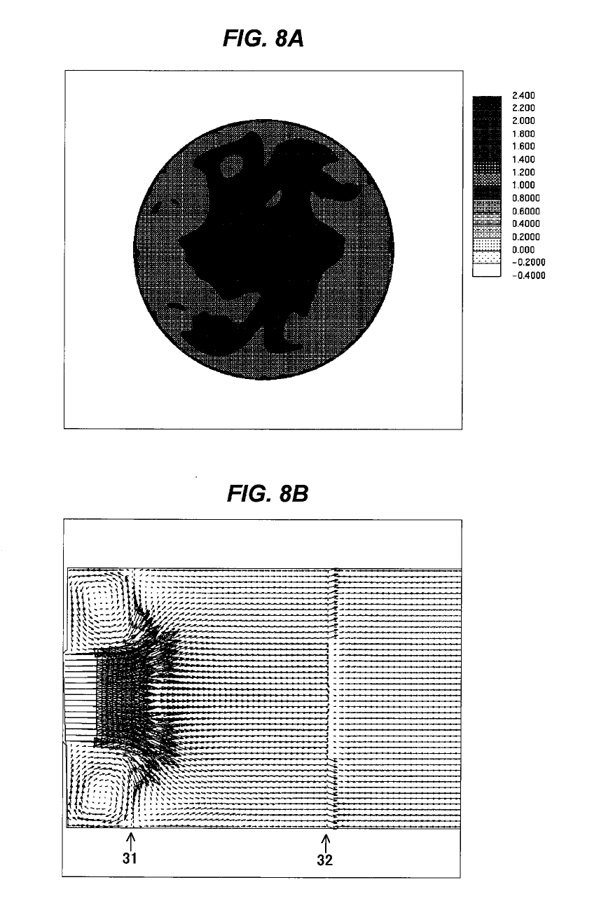

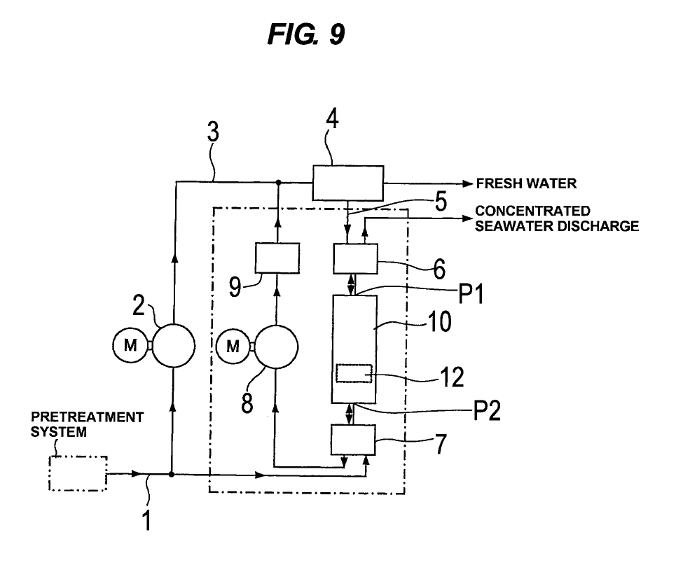

FIGS. 7A, 7B and FIG. 8A, 8B show a contour map of the flow velocities (non-dimensional) at the evaluation section and velocity vectors in the chamber obtained by CFD.

FIG. 7A is contour map of non-dimensional flow velocities by CFD analysis, in the case where parameters are selected as indicated in item 1 in the table of FIG. 4. Specifically, it shows isosurface distribution of flow velocities in the z-axial component (component of axial direction) at the evaluation section, in the case where the inner diameter of the chamber is 300 mm, the flow rate is Q×100% (L/min), the open area ratio of the first perforated plate is 35.4%, the open area ratio of the second perforated plate is 35.4%, the distance L1 is 75 mm, and the distance L2 is 75 mm. In this case, the inner diameter of each of the ports is 100 mm and the length of each of the ports is 200 mm, and the evaluation section is set at the position spaced by 150 mm from the second perforated plate toward the center of the chamber, i.e., 300 mm from the end of the chamber.

FIG. 7B shows velocity vectors in the chamber under the same conditions as FIG. 7A, and shows velocity vectors at a cross section along the axial direction of the chamber. In this figure, the positions indicated by arrows 31, 32 are the positions of the first perforated plate and the second perforated plate, respectively.

As is apparent from FIG. 7A, the distribution of the flow velocities at the evaluation section shows 14-level distribution in which values are decreased gradually from high values (2.2 to 2.4) at the central portion toward the peripheral portion, and the flow velocities at the evaluation section are non-uniform. Further, as is apparent also from the velocity vectors in the chamber in FIG. 7B, the directions and the velocities of the fluid in the chamber are non-uniform, even after the fluid passes through the first perforated plate and the second perforated plate.

FIG. 8A is a contour map of non-dimensional flow velocities by CFD analysis, in the case where parameters are selected as indicated in item 15 in the table of FIG. 4. Specifically, it shows isosurface distribution of flow velocities in the z-axial component (component of axial direction) at the evaluation section, in the case where the inner diameter of the chamber is 300 mm, the flow rate is Q×150% (L/min), the open area ratio of the first perforated plate is 53.6%, the open area ratio of the second perforated plate is 53.6%, the distance L1 is 75 mm, and the distance L2 is 225 mm. In this case, the inner diameter of each of the ports is 100 mm and the length of each of the ports is 200 mm, and the evaluation section is set at the position spaced by 150 mm from the second perforated plate toward the center of the chamber, i.e., 450 mm from the end of the chamber.

FIG. 8B shows velocity vectors in the chamber under the same conditions as FIG. 8A, and shows velocity vectors at a cross section along the axial direction of the chamber. In this figure, the positions indicated by arrows 31, 32 are the positions of the first perforated plate and the second perforated plate, respectively.

As is apparent from FIG. 8A, the distribution of the flow velocities at the evaluation section shows stable distribution in which almost constant values (0.8 to 1.0) are maintained from the central portion over the wide area, and shows one level higher values (1.0 to 1.2) in the outer area, and the flow velocities at the evaluation section are uniform. Further, as is apparent from the velocity vectors in the chamber in FIG. 8B, the directions and the velocities of the fluid in the chamber are uniform, after the fluid passes through the first perforated plate and the second perforated plate.

Although certain preferred embodiments of the present invention have been shown and described in detail, it should be understood that various changes and modifications may be made without departing from the scope of the appended claims.

What is claimed is:

1. An energy recovery apparatus for exchanging pressure energy between concentrated seawater discharged from a reverse-osmosis membrane-separation apparatus and a part of seawater to be treated by the reverse-osmosis membrane-separation apparatus in a seawater desalination system for producing fresh water from the seawater by supplying the seawater to the reverse-osmosis membrane-separation apparatus to separate the seawater into fresh water and concentrated seawater, said energy recovery apparatus comprising:
a cylindrical chamber having a space for containing concentrated seawater and seawater therein, said chamber being installed such that a longitudinal direction of said chamber is placed in a vertical direction;
a concentrated seawater port provided at a lower part of said chamber for supplying and discharging the concentrated seawater;
a seawater port provided at an upper part of said chamber for supplying and discharging the seawater;
two perforated plates provided at a concentrated seawater port side in said chamber, said two perforated plates comprising a first perforated plate and a second perforated plate which is placed more distant from said concentrated seawater port than said first perforated plate; and
two perforated plates provided at a seawater port side in said chamber, said two perforated plates comprising a first perforated plate and a second perforated plate which is placed more distant from said seawater port than said first perforated plate;
wherein said first perforated plate and said second perforated plate at the concentrated seawater port side and the seawater port side are arranged to meet one of the following three requirements:
an open area ratio of said first perforated plate is in the range of 45 to 60%;
an open area ratio of said second perforated plate is in the range of 45 to 60%; and
a distance between said first perforated plate and said second perforated plate is not less than 0.5 times of an inner diameter of said chamber.

2. The energy recovery apparatus according to claim 1, wherein said first perforated plate and said second perforated plate at the concentrated seawater port side and the seawater port side are arranged to meet one of the following requirements:
the open area ratio of said first perforated plate is in the range of 45 to 60% and the open area ratio of said second perforated plate is in the range of 45 to 60%; and
the open area ratio of said first perforated plate is in the range of 45 to 60% and the distance between said first perforated plate and said second perforated plate is not less than 0.5 times of the inner diameter of said chamber.

3. The energy recovery apparatus according to claim 1, wherein said first perforated plate and said second perforated plate at the concentrated seawater port side and the seawater port side are arranged to meet all of the following requirements:
the open area ratio of said first perforated plate is in the range of 45 to 60%;
the open area ratio of said second perforated plate is in the range of 45 to 60%; and
the distance between said first perforated plate and said second perforated plate is not less than 0.5 times of the inner diameter of said chamber.

4. The energy recovery apparatus according to claim 1, wherein the distance between said first perforated plate and said second perforated plate is in the range of 0.5 to 0.8 times of the inner diameter of said chamber.

5. A seawater desalination system for producing fresh water from seawater by supplying the seawater to a reverse-osmosis membrane-separation apparatus to separate the seawater into fresh water and concentrated seawater, said seawater desalination system comprising:
an energy recovery apparatus according to claim 1 for exchanging pressure energy between the concentrated seawater discharged from said reverse-osmosis membrane-separation apparatus and a part of the seawater to be treated by said reverse-osmosis membrane-separation apparatus.
